(19) United States
(12) Patent Application Publication
(10) Pub. No.: US 2006/0140326 A1
(43) Pub. Date: Jun. 29, 2006

(54) Portable low energy neutron source for high sensitivity material characterization

(75) Inventors: Mark S. Rowland, Alamo, CA (US); Wolfgang Stoeffl, Livermore, CA (US); Robert W. Hamm, Pleasanton, CA (US)

Correspondence Address: Deputy Laboratory Counsel For Intellectual;Property, Lawrence Livermore National Laboratory, P.O. Box 808, L-703, Livermore, CA, 94551-0808, US

(73) Assignee: The Regents of the University of CA

(21) Appl. No.: 11/248,377

(22) Filed: Oct. 11, 2005

Related U.S. Application Data
(60) Provisional application No. 60/617,526, filed on Oct. 8, 2004.

(51) Int. Cl. H05H 3/06

(52) U.S. Cl. 376/114

(57) ABSTRACT

A source of low energy neutrons based on a combination of unique technology has resulted in a man-portable package suitable for field use. This source of low energy neutrons produces a forward directed beam to permit local control and it is electrically activated so there is no radiation hazard when it is turned off for transport and relocation.

This application claims priority to U.S. Provisional Patent Application Ser. No. 60/617,526, filed Oct. 8, 2004, titled: “Portable Low Energy Neutron Source For High Sensitivity Material Characterization,” incorporated herein by reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates to techniques for the characterization of nuclear material, and more specifically, it relates to neutron sources for use in assaying nuclear material.

2. Description of Related Art

The use of neutrons for material characterization has a long history. Much of this work is carried out with “low energy ” neutrons in the range of energies from eV to tens of keV, as most materials have large nuclear cross sections at these energies. Traditional sources of neutrons are large, such as reactors and particle accelerators. Small portable sources such as isotopic neutron emitters and sealed tube neutron generators produce neutrons in the MeV range in all directions and require large hydrogenous moderators surrounding them as a shield for personnel and to produce the low energy neutrons by collisions with the moderator hydrogen atoms. For certain material characterization objectives, such as the presence of fissionable material, it is highly desirable to have a portable source of low energy neutrons that can be transported easily to field sites and quickly set up and operated. In addition, it is desirable that there be no fast neutrons in the emitted beam to be able to provide a unique signal for the presence of fission. Since a nuisance background of fast neutrons is always present with a source of fast neutrons, it is desirable that the all the neutrons given off directly by the source be at low energy. As first described by Kononov et al., by use of the nuclear reaction Li(p,n), it is possible to obtain such a beam of neutrons. Previously, all electric proton accelerators have been large (˜tons).

Neutrons provide an ideal compliment to photon based material characterization techniques. Typically, neutrons induce a plethora of signatures that may sometimes be sorted categorically and/or quantitatively to perform material characterization. The use of low energy neutrons simplifies the signature sorting, and therefore, improves the insights into what or how much materials are present In particular, low energy neutrons do not usually produce inelastic reactions and are below many of the thresholds for other types of reactions (i.e., induced fission or n-2n reactions). The benefit of these thresholds in simplifying the analysis process in some special materials cases can come from relying on the existence of some reaction (i.e., yes or no) instead of relying on the ambiguous process of quantifying increases in a ubiquitous signal. Long-lived isotopic neutron sources typically emit high-energy neutrons. Low energy neutron sources are extremely short lived (difficult to obtain) or are obtained from large accelerators located at laboratory sites.

### SUMMARY OF THE INVENTION

It is an object of the present invention to provide a portable electric proton source suitable for making low energy neutrons.

It is another object of the present inventions to provide field application for an accelerator-based neutron source.

Another object of the present inventions is to provide an electrically driven accelerator-based neutron source.

Still another object of the present inventions is to provide a neutron source that is lightweight at <150 lbs each for 3 modules.

Another object of the present inventions is to provide a rugged neutron source unit for transporting to remote locations

It is another object of the present inventions to provide an efficient accelerator driven by a portable AC power source.

Still another object of the present inventions is to provide low energy neutron output for non-destructive examinations.

Yet another object of the present inventions is to provide a directed neutron beam required for local operation.

These and other objects will be apparent to those skilled in the art based on the disclosure herein.

The present invention is a source of low energy neutrons based on a combination of unique technology that has resulted in a man-portable package suitable for field use. This source of low energy neutrons produces a forward directed beam to permit local control and it is electrically activated so there is no radiation hazard when it is turned off for transport and relocation.

A portable Radio Frequency Quadrupole (RFQ) suitable for accelerating particles useful for making neutrons (design approach) is provided. In-field material characterization is achievable with a portable, electrically generated, low energy (<100 keV) neutron source. Low energy neutrons are obtained in an accelerator where the target does not deplete, but replenishes itself. The combination vacuum system/RFQ effects size reduction in the neutron source (Cu coated Al). Real-time in-field stabilization under temperature drift is accomplished by measuring accelerator VSWR. This is used to provide feedback to a VCO to adjust the accelerating waveform to match the resonant frequency needed in the accelerator. An antenna that is located in the gas flow drives a compact ion source. An annular ion source gas fill aperture reduces the gas loading on the accelerating portion of the vacuum system. Size/weight are reduced with an air-cooling system. A low-voltage, pulsed-RF acceleration of particles approach (not a high voltage DC generator approach) is used to obtain useful nuclear reaction in the portable accelerator. The portable neutron source is directional in beam emittance, via kinematics selected by accelerating potential. Supplementary accelerating potential (not de/dx filter in Powell) is provided to tune the final beam to match (not exceed or approximate) a nuclear resonance in the target and therefore obtain the directional emittance.

Applications for this invention are found in physics research on nuclear cross sections, non-destructive assay of material, high contrast (low gamma-ray, low energy spread) neutron beams for radiography, thermal neutron radiography of parts in situ (in the field), contraband detection, neutron beam research, and in oncology (BCNT).

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1 shows neutron source yields using low energy nuclear reactions.

FIG. 2 shows neutron output energy for the ⁷Li(p,n) reaction.

FIG. 3 shows neutron output angles for a ⁷Li(p,n) reaction.

FIG. 4 shows an embodiment of the mobile neutron generator linac.

FIG. 5 shows the magnetic field change applied to an ion source.

FIG. 6 shows the final ion source performance for one embodiment.

FIG. 7 shows a side view of the source/accelerator/target assembly of one embodiment.

FIG. 8 shows a side view of a lithium target assembly.

FIG. 9 shows the target side of the 600 MHz RFQ.

FIG. 10 is a view looking down the right channel with RF “drive loop” penetrating from the side.

FIG. 11 shows an endplate.

FIGS. 12 and 13 show a Lithium target.

FIG. 14 shows a source vacuum chamber and 20 kV ceramic insulator.

FIG. 15 shows an Einzel lens and extractor cone.

FIG. 16 shows a 2.5 GHz RF amplifier and its power.

FIG. 17 shows a 7-Li proton capture reaction.

### DETAILED DESCRIPTION OF THE INVENTION

A portable, electrically generated, low energy (<100 keV) neutron source has been developed for in-field materials characterization. Many areas of novelty have been assembled into this new approach to neutron sources. This new system makes use of low-voltage, pulsed-RF acceleration (not a high voltage DC generator approach) to obtain energetic particles useful in nuclear reactions that produce low energy neutrons.

The portable accelerator includes a portable radio-frequency linear accelerator based on the Radio Frequency Quadrupole structure (RFQ) designed to accelerate charged particles of hydrogen (i.e., protons) to energies useful for producing neutrons with the (p,n) reaction on lithium. This small accelerator uses low power vacuum pumps to effect a size and weight reduction for the system as compared to more conventional approaches. The RFQ accelerator is designed with air-cooling fins integral to the one-piece vacuum system and accelerating cavity and the complete system is air cooled to reduce the size and weight of this compact accelerator unit A compact ion source developed for commercial use with heavy ion accelerators was modified to operate as a pulsed source of hydrogen ions. A boron nitride liner was placed in the plasma chamber and a new magnetic profile was developed for operation of the ion source. This ion source is driven by a coaxial feed and a spiral antenna was added to more effectively couple the microwave power into the plasma. An annular ion source extraction aperture was used to reduce the gas loading on the vacuum system while maintaining the gas pressure in the plasma chamber necessary for extracting a proton beam up to 5 milliamperes. The diameter of the annulus and the center block are sized to optimize the ion extraction and emittance to the linac. The center block is attached with small spider legs. A differential pumping scheme is used to balance the need for a high gas load on the ion source end, with its own pump and good vacuum on the accelerator end. The differential pumping scheme works by pushing the ions through a small aperture that does not conduct un-ionized gas well.

The RFQ accelerator includes resonant frequency stabilization under the temperature drift caused by operation that uses the measured accelerator rf phase to provide feedback to a wide range voltage controlled oscillator (VCO) which adjusts the drive frequency of the rf power supply to match the resonant frequency needed in the accelerator. This wide range VCO allows operation of the RFQ linac over a wide range of operating temperature (40 deg. C.) to permit operation of the system in a wide range of field environments. The linac structures were designed to operate at a high frequency to allow miniaturization of the system, requiring the development of a new high-power RF generator. A combination of solid-state components with vacuum amplifiers and a miniature cooling system represents an order of magnitude advance in power to weight ratio at this frequency (600 MHz).

The low energy neutrons are obtained from this system from the bombardment of a lithium-coated target by the energetic protons. The thin layer of lithium on the target does not deplete, but replenishes itself due to the beta decay process. It is covered with a very thin layer of inert material to prevent oxidation. The target assembly is mounted on the output of the accelerator with high voltage isolation so that a bias can be used on the target to make fine adjustments to the energy of the protons hitting the target to compensate for the energy lost in the passivation and to adjust the beam energy to provide neutrons only in the forward direction. This supplementary accelerating potential is not a de/dx filter as in Powell, but is used to tune the final beam to not exceed a limit above the threshold in the Li(p,n) nuclear reaction so that the emitted neutrons are only in the forward direction.

The RFQ accelerator, ion source, rf power supply and all ancillary equipment are housed in two lightweight packages that are two man portable and capable of being interconnected to effect full operation rapidly. The lightweight housings use modern carbon fiber covers to make them rugged and capable of protecting the system from damage while not affecting the neutrons emitted from the target.

There are many possible scenarios for active interrogation of container cargo. Compared to a classic nuclear physics laboratory environment, cargo scanning has to deal with an enormous amount of background discrimination and attenuation, which makes it a very different problem from previous measurements designed to measure nuclear properties in a clutter free environment The main problem is the enormous thickness and variety of the possible intervening material, approaching the thickness of nuclear reactor shielding walls. For some scenarios, either gamma rays or neutrons cannot penetrate the cargo efficiently. On the other hand, it is very difficult to shield both gamma (or X-rays) and neutron penetration at the same time when there is a limit on the weight of the shielding. For gamma rays, heavy elements are difficult to penetrate, for neutrons, light elements like plastic and water are difficult One very promising active interrogation method includes a combination of 3 different methods to cover all possible scenarios.

For rather unshielded SNM like Uranium 235 (mixed with U238) or Pu239 and other SNM materials are easily detected by passive radiation measurement with large gamma ray scintillation detectors and thermal neutron detectors.

A heavy material shielded container in a light neutron absorbing surrounding is easily observed with a high energy X-ray scan of the cargo, preferable 2-axis and two different X-ray energies for better material identification. Such is like a large airport luggage scanner. The detection of a heavy and very dense object in the middle of a large amount of hydrogenous material (like oranges in crates) will be very suspicious and is usually not encountered in normal shipping containers.

Active neutron interrogation of a container without a large amount of homogeneously distributed hydrogenous material can unmistakably detect the presence of SNM. The active interrogation needs to be exclusively sensitive and specific to SNM like 235U or 239Pu, and not confused by passive materials like Thorium, which is present in many materials at a significant level. The return signal of the active interrogation has to be unique to the presence of SNM, and should produce no signal from the many tons of “inert” material present in a typical container.

There is one unique method of interrogation which is very specific to SNM and produces an essentially background free return signal very specific to SNM: Sending out medium energy neutron in the energy range between 10 and 200 keV, and observing the induced 1 to 5 MeV fission neutrons from SNM with pulse shape and energy discriminating scintillation detectors. This method produces an nearly background free identification signal for SNM. Even a small number of detected fast neutrons will be a positive signal, since the fast neutron background from natural sources is very low.

The source of medium energy neutrons is the (p,n) reaction of a 2 MeV proton beam on a 7-Li target Since the early days of nuclear physics it has been known that one can produce medium energy neutrons with the ⁷Li(p,n) reaction. But since there was little physics use for a medium energy neutron source, this reaction was rarely used and very few accelerators have been built to make use of this reaction. The reaction has a threshold of 1.88 MeV and the cross section rises to its full value within 20 keV proton beam energy. It is a very sharp threshold reaction. If one chooses a proton energy just above the reaction threshold, it is possible to restrict the neutron emission pattern to a 60 degree forward cone. There are no neutrons emitted backwards from the target The narrow opening angle enhances the effective forward neutron flux by a factor 10 compared to 4π emission sources and reduces the neutron activation of the surrounding dramatically. There is also no need for bulky and heavy sideway neutron shielding. Having no need for bulky shielding, one can place the fast neutron detectors rather close to the accelerator and target.

The reaction produces a kinematically forward focused neutron beam, requiring little sideway shielding. Since the outgoing neutrons have rather low energy, the radiation dose delivered to the cargo is rather low and not a threat to equipment or humans in the cargo. Neutron production rates can be as high as 10¹⁰ per second into a 1 steradian cone, equivalent to a ten times higher strength source emitting into 4π with a strong source, one can scan a complete cargo container in much less than 1 minute. The 2 MeV accelerator that is used for producing the required 2 MeV neutron beam is less than half the size of a typical office desk, is portable, plugs into a regular electrical outlet and requires no cooling water. There is the possibility to build a very tightly focused neutron beam by reversing the ⁷Li(p,n) reaction to ¹H(⁷Li,n). The benefit is a very narrow and high brightness neutron beam, the drawback is that the accelerator to produce 14 MeV ⁷Li is much larger and much more expensive.

The fast neutron sensitive detectors are a key to the nearly background free detection of SNM. Sending out a high flux of neutrons into a random cargo will produce a significant gamma radiation, since most neutrons will not die “gracefully” without the emission of very energetic gamma rays. The typical neutron capture reaction releases about 7-8 MeV of gamma rays, independent if the reaction product is a stable nucleus or not The detector has to be able to distinguish between the gamma rays and and the energetic neutrons. Discriminating liquid scintillator detectors were developed many years ago, and the pulse shape discriminating read-out electronics has been steadily improved in the last 20 years. The development was mainly driven by the development of low background detectors for deep underground astrophysics instruments.

The gamma-neutron separation is very much influenced by the actual count rate in the detector, so it is beneficial to keep the absolute count rate rather low to eliminate pileup confusion. The typical detector array is segmented to keep the individual detectors volume to less than 1 liter. Several arrays of 1 square meter on each side of the neutron source and on the opposite sides of the container will be sufficient.

Our tests have shown that we have near zero background in our fast neutron detectors, even while the interrogating neutron beam is on. This makes it possible to detect SNM with only a few tens or hundreds of counted high-energy fission neutrons. We plan to improve the gamma to neutron separation by implementing a digital event readout and analyzing each potential fast neutron pulse by software. Since the fast neutron count rate is rather small, a sophisticated analysis of the pulse shape and its decay structure can be performed. When neutrons collide with hydrogen nuclei in the detector material, they can transfer much of their energy to the hydrogen nucleus. The recoiling proton excites different molecular states in the scintillator compared to a fast electron produce by a gamma ray interaction. The light decay time for a proton induced light pulse is much longer than the electron induced pulse. A clever analog electronic circuit can distinguish the pulse shape, but may be confused at high-count rates. A fully digital readout will practically eliminate this problem and give a much cleaner neutron signal, even in a high gamma ray environment To reduce the total count rate in the detector without losing too many neutrons, we shield the detector array behind a 1 inch lead wall. The shielding thickness has to be optimized.

The free path length of fast neutrons in materials is rather short, typically between 2 and 5 cm for most materials. The free path length between elastic scatterings is surprisingly independent of atomic mass, making most materials look the same for neutron penetration. The only exception is hydrogenous material like polyethylene or water. There the typical scattering length is less than 2 cm, making it harder to diffuse neutrons. Neutrons lose some energy in every collision; the typical loss is proportional to the atomic weight ratio of the neutron and the scattering nucleus. Neutrons lose their energy very fast in water, but they can scatter for many meters in heavy material before they thermalize and are ultimately captured.

In water, the useful diffusion depth is about 30 cm. In heavy materials, a container full of tools or electronics is not an obstacle. The 60 keV outgoing neutrons will have penetration depth of about ½ of a multi-MeV neutron beam. Most of the diffusion length comes from the random walk of the ever-slowing neutrons at lower energies. The energy loss is an exponential process, so very energetic neutrons rapidly slow down to medium energies, and then follow the same diffusion path as original 60 keV neutrons. At higher energies, neutrons lose much of their energy by inelastic excitation of the target nuclei, producing unwanted additional gamma radiation.

A large portion of the fission reaction in SNM is caused by thermalized neutrons. Here the fission cross-section is very large for 235U and 239Pu. The fast fission neutrons with an average energy of 2 MeV have to be able to exit the container, reversing the path of the interrogating neutrons. Only neutrons that do not lose too much energy on their way out can be counted, since the area is flooded with low energy interrogating neutrons.

When using high-energy neutrons for interrogation and waiting for the 1% delayed neutron fraction after the probing pulse is turned off, the problem of penetration depth is reversed. The high-energy inward neutrons have a somewhat deeper penetration potential but the delayed neutrons returning to the detector have only an average energy of 400 keV. So the problem of reduced penetration depth is essentially reversed for high-energy neutron interrogation. If high-energy fission gamma rays are used for the return signal, the low energy neutron problem is circumvented. But the difficulty with prompt or delayed fission gamma rays is the fact that most are at low energy, and rather few are in the multi-MeV region with very few and weak distinct lines. The fission products are spread out over many different isotopes.

Most neutrons will scatter in the cargo material until the neutron reaches thermal energy, and only then are they lost by a capture reaction. Most bulk materials with very few exceptions have very small capture cross-sections for energetic neutrons. The elastic scattering energy loss mechanism depends strongly on the atomic mass of the material; in non-hydrogen bearing material it takes hundreds or thousands of scattering reaction to reach thermal neutron energies. The long random walk path of the neutron allows it to diffuse up to 1 meter without severe attenuation. If large amounts of hydrogen are present, the neutrons can lose their energy much faster and the penetration depth is reduced. But even fast neutrons lose part of their energy in the first few collisions and then follow the same path as lower energy neutrons.

The natural fast neutron background in the open environment is very low. Neutrons can be generated by cosmic muon induced spallation reactions in the soil and atmosphere. The typical muon flux at the surface of the earth is approximately 100 muon/m²/sec, and the associated fast neutron flux is about a factor 10 lower. If the interrogating neutron source is pulsed, most of the natural background can be gated out, reducing the effective natural neutron flux to less than 1 neutron/m²/sec. With a short measurement time, even a small number of returned fast neutrons can indicate the presence of SNM. No other material can produce fast neutrons when using medium energy neutrons as an interrogation tool. The threshold for (p,n) reaction on most materials is out of energy range for natural occurring radioactive elements. The very few materials with low neutron producing reaction thresholds can easily be detected by other means.

Since the medium energy neutron interrogation technique is exclusively sensitive to actual SNM nuclei, there is no substitute available for testing and calibrations. This raises an interesting problem that one needs actual SNM material to test the operational performance of the detection system. But low enriched SNM material is sufficient to test and calibrate the detection system.

We developed a working system for active neutron interrogation by selecting a reaction that is very exclusive to the detection of SNM and is not compromised by natural background reactions. 60 keV neutrons can penetrate cargo quite efficiently. The exception is cargo that has high hydrogen content, but X-rays can easily penetrate such cargo. Fast neutrons are only produced by SNM material, normal cargo does not produce any background. Detecting fast neutrons on both sides of the cargo gives a clean signal, where the detection of even a few dozen beam-time-correlated fast neutrons is enough for a clean detection. We demonstrated that the fast neutron detection system is insensitive to the interrogation medium energy neutron beam. This allows us to measure the fast neutron return signal while the interrogation beam is on, using the full intensity of the fast fission neutrons produced. The system is insensitive to ²³⁸U and Thorium that are always present in significant amounts in all materials. It is also insensitive to all other non-SNM material. It delivers a very low biological radiation dose to the cargo for effective detection of SNM.

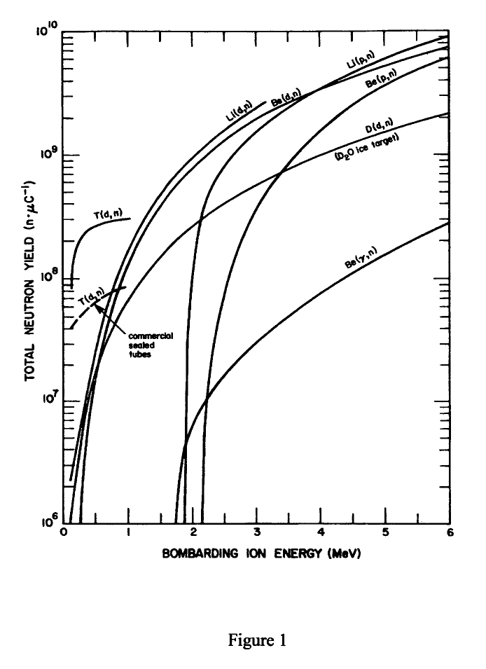

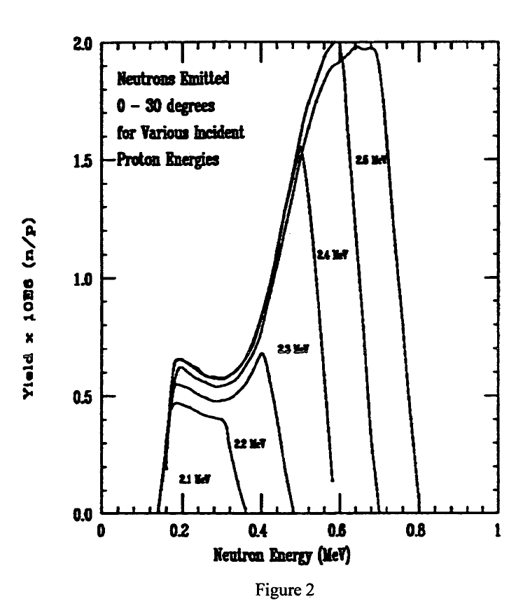

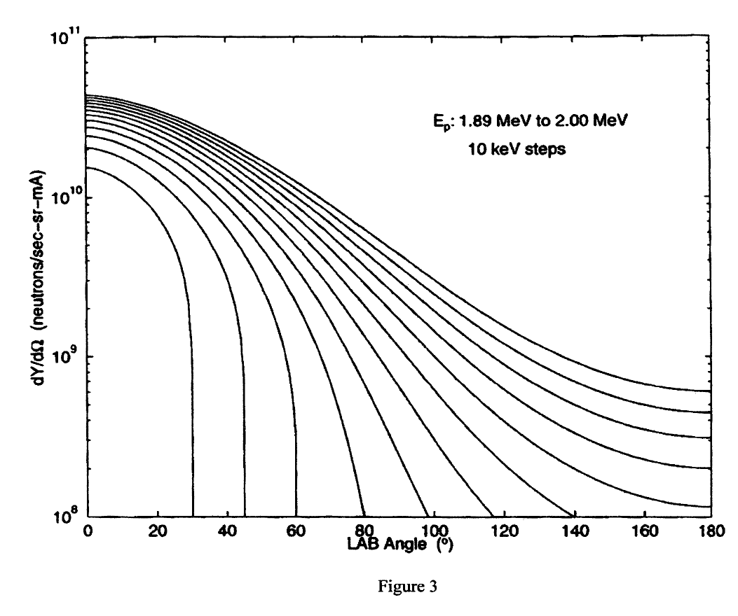

FIG. 1 shows neutron source yields using low energy nuclear reactions. FIG. 2 shows neutron output energy for the ⁷Li(p,n) reaction. FIG. 3 shows neutron output angles for a ⁷Li(p,n) reaction. Specifications for one embodiment of a mobile neutron generator are provided in Table 1 below.

| | |
|---|---|
| Accelerated Ions | H+ |
| Output beam energy | 1.93 ± .02 MeV |
| Output beam current | 0.1-5 mA |
| Beam repetition rate | 50-500 Hz |
| Beam pulse width | 1-95 μsec |
| Max. RF duty factor | 0.5% |
| RF peak power (max.) | 120 kW |
| Average beam current | 0.10-25 mA |
| Neutron output | 2 × 10⁶-6 × 10⁸ n/sec |
| Vacuum pressure | <1 × 10⁻⁶ torr |
| Vacuum pumps | NEG pumps |
| Cooling | Forced air |
| Input AC power | 220 V, 1 ph, 10 A (2.2 kW) |

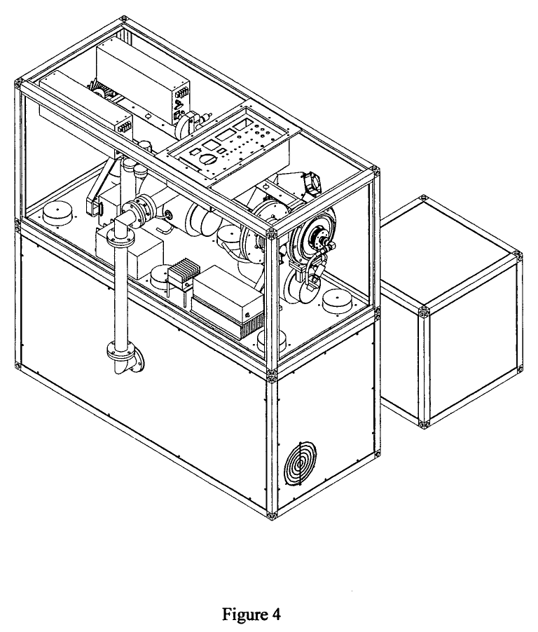

Some of the components of the mobile nutron generator are: Ion Injectors; Microwave ion source with Einzel lens focusing; Radio-frequency quadrupole (RFQ); A 600 MHz air-cooled RFQ; Target; sealed lithium target isolated for bias voltage; RF Power; compact planar triode system with 150 kW pulsed output (JPAW); Vacuum System; SAES NEG pumps with small ion pump; Controls; and manual panel on top of unit FIG. 4 shows an embodiment of the mobile neutron generator linac. RFQ Parameters for one embodiment are provided in table 2 below.

TABLE 2

| | | |
|---|---|---|
| Operating frequency | 600 | MHz |
| Input beam energy | 18.0 | keV |
| Output beam energy | 1.93 | MeV |
| Vane length | 81.5 | cm |
| Average bore radius (r₀) | 1.39 | mm |
| Intervane voltage (V₀) | 55.5 | kV |
| Cavity rf power (theoretical × 1.4) | 98 | kW |
| Calculated beam transmission | 90.7% | |
| Output energy spread (95%) | ±20 | keV |
| Input acceptance (norm, 95%) | 0.52 | p mm-mrad |
| Current limit | 36 | mA |

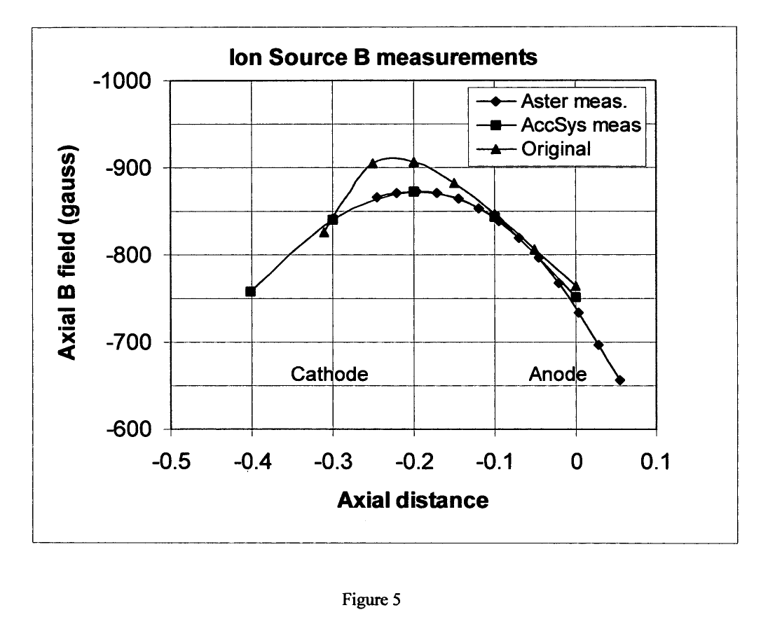

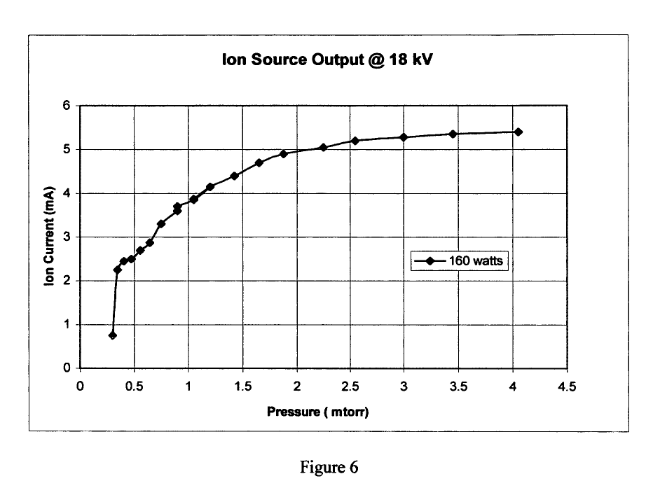

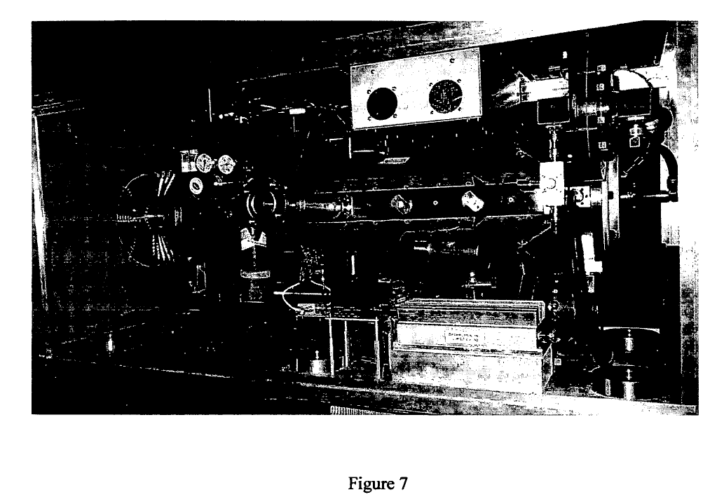

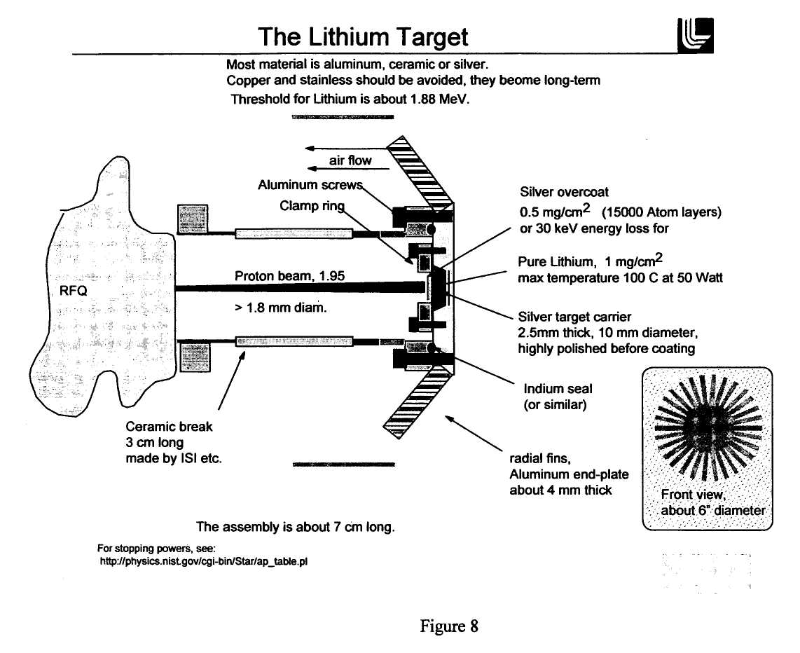

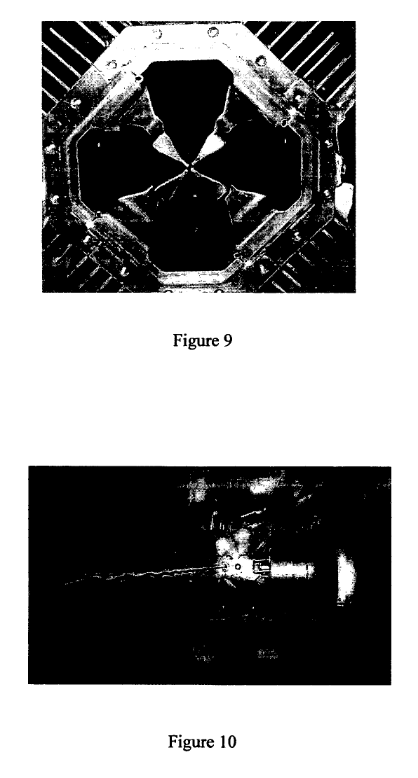

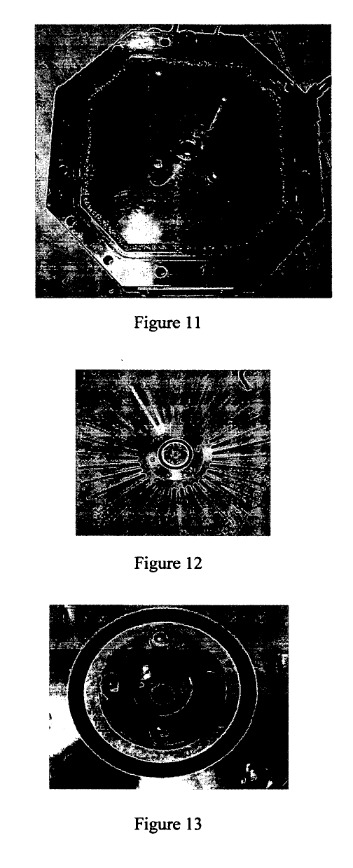

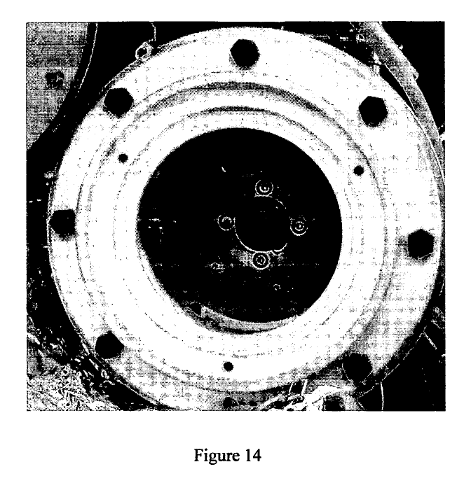

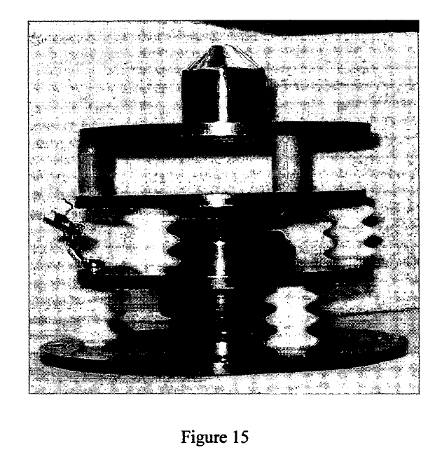

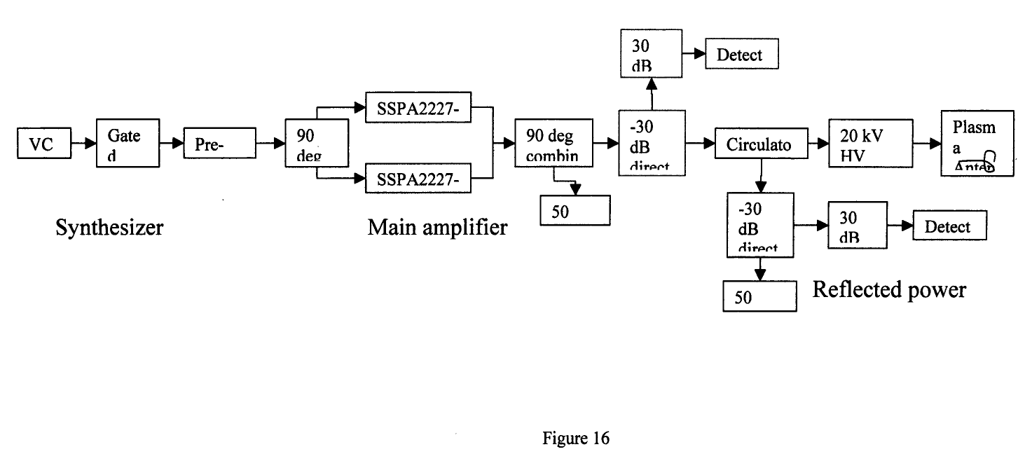

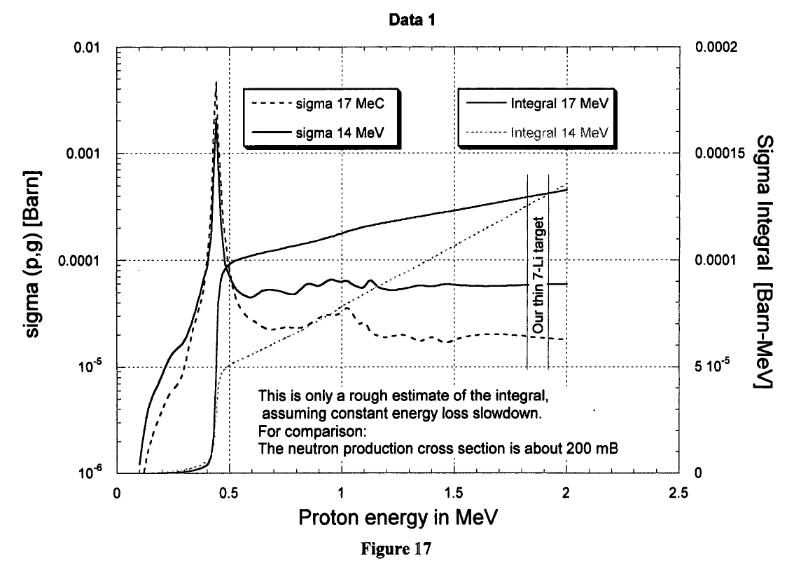

FIG. 5 shows the magnetic field change applied to the ion source. FIG. 6 shows the final ion source performance for one embodiment FIG. 7 shows a side view of the source/accelerator/target assembly of one embodiment FIG. 8 shows a side view of a lithium target assembly. FIG. 9 shows the target side of the 600 MHz RFQ. The 4 vane tips produce a 70 kV p-p gradient with a net forward propulsion. FIG. 10 is a view looking down the right channel with RF “drive loop” penetrating from the side; The left shows the convoluted path channel for the protons. FIG. 11 shows the endplate has 4 tuning plugs to shift the phase of each segment by a quarter wave. Also visible is the RF seal. The beam exits through the hole in the middle. FIGS. 12 and 13 show the little dark spot in the middle is the 10 micrometer thick Lithium target, 5 mm diameter, coated with 100 nm Chromium and 100 nm Aluminum, on a 2 mm thick Silver backing. FIG. 14 shows the source vacuum chamber and 20 kV ceramic insulator. The proton beam enters the RFQ through the small hole in the middle. The current measuring toroid surrounds the hole. FIG. 15 shows the Einzel lens and extractor cone. FIG. 16 shows The 2.5 GHz RF amplifier and its power. FIG. 17 shows a 7-Li proton capture reaction.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method of producing neutrons, comprising:
bleeding hydrogen gas into a cavity through an opening at a first end, wherein said cavity further comprises an orifice at a second end an an antenna inside said cavity;
exciting said hydrogen gas with adjustable frequency RF power from an adjustable RF linear amplifier, wherein said frequency is adjusted to maximize the production of ionized protons within said cavity;
providing an electrostatic field across said cavity from said first end to said second end, wherein said first end is negative and said second end is positive, wherein ionized protons will drift in the direction of said second end and through said orifice, wherein an ion accelerator is operatively connected to said cavity to receive said ions as they pass through said orifice;
differentially vacuum pumping across said orifice, wherein the vacuum on the cavity side of said orifice is not as evacuated as the cavity on the accelerator side of said orifice;
accelerating said ionized protons with the voltage output of a solid state linear RF generator; adjusting the frequency output of said solid state linear RF generator to maximize the number of accelerated protons; and
directing said accelerated protons onto lithium coated silver target to produce neutrons, wherein said target is thermally connected to radial cooling fins.

2. The method of claim 1, wherein said cavity comprises metal lined with ceramic insulating material.

3. The method of claim 1, further comprising providing a reasonably homogenious magnetic field along said cavity to make use of electron cyclotron resonance.

4. The method of claim 1, wherein said adjustable frequency RF power is provided by creating microwave power by a frequency synthesized signal, amplifying said microwave power through a set of power RF amplifiers, wherein the RF signal is decoupled from the ground potential by transferring the RF signal from a coaxial cable to a waveguide, wherein the RF wave penetrates an electrically insulating barrier and gets converted back to a now electrically floating RF signal.

5. The method of claim 4, wherein said frequency is adjusted by adjusting a magnetic field surrounding said cavity to compensate for changes in the magnetic field due to temperature by moving magnetic field creating permanent magnets closer to said cavity.

6. The method of claim 5, wherein said magnetic field creating permanent magnets are moved closer to said cavity by embedding permanent magnet rods in a plastic matrix which pushes the magnets inward when the temperature rises.

7. The method of claim 5, further comprising floating said cavity and its RF antenna at a positive high voltage potential, and accelerating said protons through a set of Einzel lenses into the input aperture of said accelerator

8. The method of claim 7, wherein said accelerator comprises a Radio-frequency Quadrupole (RFQ) accelerator.

9. The method of claim 8, wherein said RFQ accelerator a copper or silver coating.

10. The method of claim 1, wherein said solid state linear RF generator creates the needed RF microwave power at about 150 kW, 600 MHz

11. The method of claim 10, wherein said solid-state linear RF generator is liquid cooled.

12. The method of claim 1, wherein the step of adjusting the frequency output of said solid state linear RF generator comprises adjusting a quartz crystal stabilized frequency with the help of an automatic feedback to keep the frequency optimized when said accelerator cavity changes temperature, changing the resonant frequency of said cavity.

13. The method of claim 1, wherein said protons are accelerated to an energy of approximately 1930 keV to penetrate the protective coating of said target and to arrive at said target just above the nuclear reaction threshold of 1880 keV.

14. The method of claim 1, further comprising eliminating backward emitted neutrons from said target by kinematically focusing said neutrons in the forward direction.

15. The method of claim 1, further comprising eliminating the production of energetic neutrons.

16. The method of claim 1, wherein said target is thermally connected to radial cooling fins.

17. The method of claim 1, further comprising protecting the thin lithium target with a thin coating of oxygen tight material to prevent oxidation of the lithium and reducing the neutron output.

18. The method of claim 1, further comprising keeping the lithium target thin enough not to slow the protons inside the lithium to an energy of less than 500 keV.

19. A neutron source, comprising:
a cavity;
means for bleeding hydrogen gas into said cavity through an opening at a first end, wherein said cavity further comprises an orifice at a second end an an antenna inside said cavity;
an adjustable RF linear amplifier for exciting said hydrogen gas, wherein said frequency is adjusted to maximize the production of ionized protons within said cavity;
means for providing an electrostatic field accross said cavity from said first end to said second end, wherein said first end is negative and said second end is positive, wherein ionized protons will drift in the direction of said second end and through said orifice, wherein an ion accelerator is operatively connected to said cavity to receive said ions as they pass through said orifice;
means for differentially vacuum pumping across said orifice, wherein the vacuum on the cavity side of said orifice is not as evacuated as the cavity on the accelerator side of said orifice;
a solid state linear RF generator to provide a voltage for accelerating said ionized protons; means for adjusting the frequency output of said solid state linear RF generator to maximize the number of accelerated protons; and
a lithium coated silver target to produce neutrons, an means for directing said accelerated protons onto said target, wherein said target is thermally connected to radial cooling fins.

20. The method of claim 1, wherein said cavity comprises metal lined with ceramic insulating material.
